(19) United States
(12) Patent Application Publication
(10) Pub. No.: US 2023/0397256 A1
(43) Pub. Date: Dec. 7, 2023

(54) METHODS, APPARATUS AND SYSTEMS FOR PREAMBLE AGGREGATION IN A RANDOM ACCESS PROCEDURE

(71) Applicant: ZTE Corporation, Shenzhen (CN)

(72) Inventors: Xiyu WANG, Shenzhen (CN); Junfeng ZHANG, Shenzhen (CN); Xing LIU, Shenzhen (CN); Peng HAO, Shenzhen (CN)

(21) Appl. No.: 18/123,747

(22) Filed: Mar. 20, 2023

Related U.S. Application Data
(63) Continuation of application No. PCT/CN2020/118237, filed on Sep. 28, 2020.

(51) Int. Cl. H04W 74/08

(52) U.S. Cl. CPC H04W 74/0833; H04W 74/0891

(57) ABSTRACT

Methods, apparatus and systems are described for preamble aggregation in a random access procedure. In one embodiment, a method performed by a wireless communication device for preamble aggregation is disclosed. The method includes: transmitting, to a wireless communication node, a first message comprising a number of copies of a preamble for an access to the wireless communication node, wherein the number is an integer larger than one, and wherein the copies of the preamble are carried by different uplink random access channel (RACH) occasions respectively; and monitoring, within a response time window, for a second message comprising a response to the first message from the wireless communication node, wherein all of the copies of the preamble are transmitted before the response time window expires.

### CROSS-REFERENCE TO RELATED APPLICATIONS

This application is a continuation of International Appl. No. PCT/CN2020/118237, filed on Sep. 28, 2020, which is incorporated by reference herein in its entirety.

### TECHNICAL FIELD

The disclosure relates generally to wireless communications and, more particularly, to methods, apparatus and systems for preamble aggregation in a random access procedure in a wireless communication.

### BACKGROUND

The fifth Generation (5G) new radio (NR) mobile communications will be systematically networked on carrier frequencies higher than those used in 2G, 3G, and 4G systems. Currently, the industry has widely and internationally recognized frequency bands of mainly 3 GHz to 6 GHz, 6 GHz to 100 GHz. As compared to the networking frequency of earlier communication systems, these bands are relatively high, the loss is greater in propagation, and similarly the coverage radius is relatively small under the same power. To align the similar coverage with the traditional system such as 2G, 3G, and 4G, the coverage of 5G new generation of mobile communication systems should be enhanced especially for the initial access channel.

In a traditional four-step long-term evolution (LTE) or NR random access procedure, the first step is for a user equipment (UE) to send a physical random access channel (PRACH) signal, e.g. a preamble or Message (Msg) 1. The second step is for the network to send a random access response (in Msg 2) to the UE after receiving the PRACH. Then the UE tries to detect the random access response. If the response time window for detecting a random access response expires, or if the UE cannot decode the respective random access response, or if the random access preamble identifier in the random access response does not match the transmitted preamble index in PRACH, then the UE will consider the random access response reception to be not successful, and will initiate a retransmission of the PRACH. The RACH response window length is at least 10 ms, which means latency caused by the retransmission after the response window expires will be huge and cannot be accepted by some latency sensitive service, e.g. ultra-reliable low-latency communication (URLLC) service.

Both NR system and NR UEs have the capability of transmission of multiple beams. Each beam can focus the radio signal energy to one specific direction and improve the coverage and successful access probability. The investigation of the best beam for transmitting and receiving is important for NR system and UEs. From the perspective of UE, based on the reciprocity principle, the direction of the best receiving beam at UE side is likely to be the direction of the best transmitting beam of UE. But sometimes the direction of the best transmitting beam of UE may not be the direction of the best receiving beam of UE, when the reciprocity at UE side is not so perfect in a realistic scenario. Discovering the best transmitting beam should be done in the initial access procedure. A traditional beam switch only occurs on the retransmission of PRACH after the response window expires. As such, discovering the best transmitting beam in a traditional method causes undesired latency, which is the same problem mentioned above regarding traditional PRACH retransmission.

### SUMMARY

The exemplary embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

In one embodiment, a method performed by a wireless communication device for preamble aggregation is disclosed. The method includes: transmitting, to a wireless communication node, a first message comprising a number of copies of a preamble for an access to the wireless communication node, wherein the number is an integer larger than one, and wherein the copies of the preamble are carried by different uplink random access channel (RACH) occasions respectively; and monitoring, within a response time window, for a second message comprising a response to the first message from the wireless communication node, wherein all of the copies of the preamble are transmitted before the response time window expires.

In another embodiment, a method performed by a wireless communication node for preamble aggregation is disclosed. The method includes: receiving, from a wireless communication device, a first message comprising a number of copies of a preamble for an access to the wireless communication node, wherein the number is an integer larger than one, the copies of the preamble are carried by different uplink random access channel (RACH) occasions respectively; and transmitting, to a wireless communication device, a second message comprising a response to the first message, wherein the second message is monitored within a response time window by the wireless communication device, and all of the copies of the preamble are transmitted by the wireless communication device before the response time window expires.

In a different embodiment, a wireless communication node configured to carry out a disclosed method in some embodiment is disclosed. In another embodiment, a wireless communication device configured to carry out a disclosed method in some embodiment is disclosed. In yet another embodiment, a non-transitory computer-readable medium having stored thereon computer-executable instructions for carrying out a disclosed method in some embodiment is disclosed.

### BRIEF DESCRIPTION OF THE DRAWINGS

Various exemplary embodiments of the present disclosure are described in detail below with reference to the following Figures. The drawings are provided for purposes of illustration only and merely depict exemplary embodiments of the present disclosure to facilitate the reader's understanding of the present disclosure. Therefore, the drawings should not be considered limiting of the breadth, scope, or applicability of the present disclosure. It should be noted that for clarity and ease of illustration these drawings are not necessarily drawn to scale.

FIG. 1 illustrates an exemplary communication network in which techniques disclosed herein may be implemented, in accordance with some embodiments of the present disclosure.

FIG. 2 illustrates an exemplary random access procedure, in accordance with some embodiments of the present disclosure.

FIG. 3 illustrates a block diagram of a base station (BS), in accordance with some embodiments of the present disclosure.

FIG. 4 illustrates a flow chart for a method performed by a BS for performing preamble aggregation in a random access procedure, in accordance with some embodiments of the present disclosure.

FIG. 5 illustrates a block diagram of a user equipment (UE), in accordance with some embodiments of the present disclosure.

FIG. 6 illustrates a flow chart for a method performed by a UE for performing preamble aggregation in a random access procedure, in accordance with some embodiments of the present disclosure.

FIG. 7A illustrates an exemplary scheme for preamble aggregation, in accordance with some embodiments of the present disclosure.

FIG. 7B illustrates another exemplary scheme for preamble aggregation, in accordance with some embodiments of the present disclosure.

FIG. 8A illustrates an exemplary hybrid scheme for preamble aggregation, in accordance with some embodiments of the present disclosure.

FIG. 8B illustrates another exemplary hybrid scheme for preamble aggregation, in accordance with some embodiments of the present disclosure.

FIG. 9 illustrates exemplary allocations of random access channel (RACH) occasions for different aggregation levels, in accordance with some embodiments of the present disclosure.

FIG. 10 illustrates an exemplary resource allocation of distributed RACH occasions (ROs) for preamble aggregation, in accordance with some embodiments of the present disclosure.

FIG. 11 illustrates another exemplary resource allocation of distributed ROs for preamble aggregation, in accordance with some embodiments of the present disclosure.

FIG. 12 illustrates yet another exemplary resource allocation of distributed ROs for preamble aggregation, in accordance with some embodiments of the present disclosure.

FIG. 13 illustrates an exemplary resource allocation of localized ROs for preamble aggregation, in accordance with some embodiments of the present disclosure.

### DETAILED DESCRIPTION OF EXEMPLARY EMBODIMENTS

Various exemplary embodiments of the present disclosure are described below with reference to the accompanying figures to enable a person of ordinary skill in the art to make and use the present disclosure. As would be apparent to those of ordinary skill in the art, after reading the present disclosure, various changes or modifications to the examples described herein can be made without departing from the scope of the present disclosure. Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

A typical wireless communication network includes one or more base stations (typically known as a “BS”) that each provides geographical radio coverage, and one or more wireless user equipment devices (typically known as a “UE”) that can transmit and receive data within the radio coverage. In the wireless communication network, a BS and a UE can communicate with each other via a communication link, e.g., via a downlink radio frame from the BS to the UE or via an uplink radio frame from the UE to the BS.

The present disclosure provides methods and systems for a terminal or a UE to complete an initial access to a BS with a reduced latency. In some embodiments, a PRACH aggregation or preamble aggregation scheme is utilized by the UE before a response time window expires, to reduce the latency of initial access caused by the retransmission of PRACH. This also enhances the coverage of uplink initial access channel, e.g. the PRACH channel. In some embodiments, the PRACH aggregation or preamble aggregation scheme is also utilized by the UE to discover the best transmitting beam with a reduced latency during the initial access procedure. That is, the disclosed method can help a UE to find the best transmitting beam and improve the successful access probability at the same time.

The methods disclosed in the present teaching can be implemented in a wireless communication network, where a BS and a UE can communicate with each other via a communication link, e.g., via a downlink radio frame from the BS to the UE or via an uplink radio frame from the UE to the BS. In various embodiments, a BS in the present disclosure can be referred to as a network side and can include, or be implemented as, a next Generation Node B (gNB), an E-UTRAN Node B (eNB), a Transmission/Reception Point (TRP), an Access Point (AP), an AP MLD, a non-terrestrial reception point for satellite/fire balloon/unmanned aerial vehicle (UAV) communication, a radio transceiver in a vehicle of a vehicle-to-vehicle (V2V) wireless network, etc.; while a UE in the present disclosure can be referred to as a terminal and can include, or be implemented as, a mobile station (MS), a station (STA), a non-AP MLD, a terrestrial device for satellite/fire balloon/unmanned aerial vehicle (UAV) communication, a radio transceiver in a vehicle of a vehicle-to-vehicle (V2V) wireless network, etc.

In various embodiments of the present teaching, the two ends of a communication, e.g., a BS and a UE, may be described herein as non-limiting examples of “wireless communication node,” and “wireless communication device” respectively, which can practice the methods disclosed herein and may be capable of wireless and/or wired communications, in accordance with various embodiments of the present disclosure.

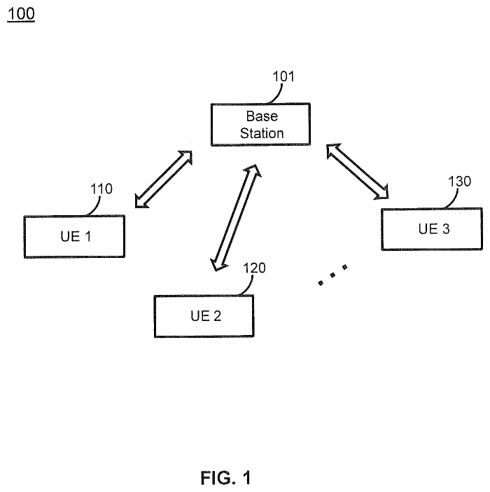

FIG. 1 illustrates an exemplary communication network 100 in which techniques disclosed herein may be implemented, in accordance with an embodiment of the present disclosure. As shown in FIG. 1, the exemplary communication network 100 includes abase station (BS) 101 and a plurality of UEs, UE 1 110, UE 2 120 . . . UE 3 130, where the BS 101 can communicate with the UEs according to wireless protocols. A UE may move into the coverage of the BS 101 and intends to communicate with the BS 101. To communicate with the BS 101, the UE first performs an initial access to the BS 101, e.g. following a random access procedure.

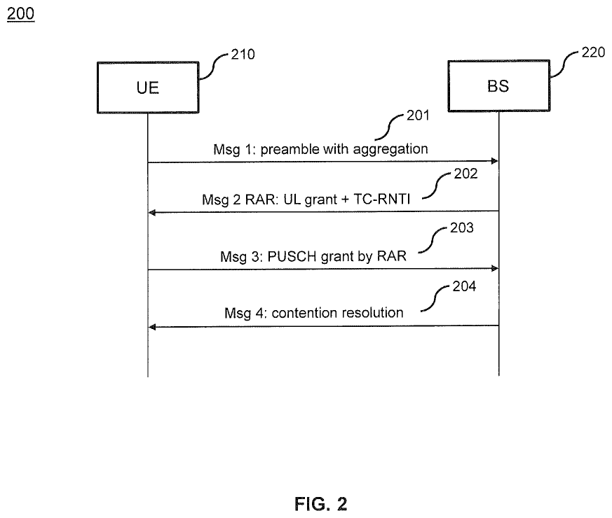

An exemplary four-step random access procedure 200 is shown in FIG. 2. As shown in FIG. 2, a UE 210 transmits a Message (Msg) 1 to a BS 220 at operation 201. In this example, Msg 1 includes an aggregation of a preamble, i.e. multiple copies of a same preamble, to improve the probability of successful access to the BS 220. Once the Msg 1 is received successfully (e.g. at least one copy of the preamble is successfully received) by the BS 220, the BS 220 will send at operation 202 a Msg 2 back to the UE 210, in which a medium access control (MAC) random access response (RAR) is included as a response to the preamble. When the BS 220 receives multiple copies of the same preamble, the BS 220 may generate the Msg 2 based on a combination of the multiple preamble copies. The MAC RAR may include an uplink (UL) grant and a temporary cell radio network temporary identifier (TC-RNTI). After the MAC RAR is received, the UE 210 transmits Msg 3 at operation 203 to the BS 220 according to the physical uplink shared channel (PUSCH) grant carried in the MAC RAR. After the Msg 3 is received, the BS 220 will send the Msg 4 back at operation 204 to the UE 210, in which some kind of contention resolution identity (ID) will be included for the purpose of contention resolution. Although a four-step random access channel (RACH) procedure is illustrated here, the preamble aggregation scheme disclosed herein can also be implemented with a two-step RACH procedure as well, to further accelerate the entire initial access procedure and significantly reduce the overall initial access latency of the communication network, in accordance with some embodiments of the present disclosure.

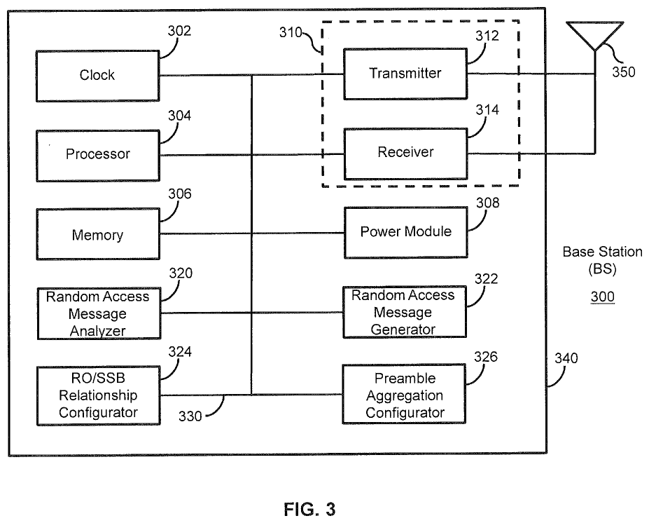

FIG. 3 illustrates a block diagram of a base station (BS) 300, in accordance with some embodiments of the present disclosure. The BS 300 is an example of a node that can be configured to implement the various methods described herein. As shown in FIG. 3, the BS 300 includes a housing 340 containing a system clock 302, a processor 304, a memory 306, a transceiver 310 including a transmitter 312 and receiver 314, a power module 308, a random access message analyzer 320, a random access message generator 322, a RACH occasion/synchronized signal block (RO/SSB) relationship configurator 324, and a preamble aggregation configurator 326.

In this embodiment, the system clock 302 provides the timing signals to the processor 304 for controlling the timing of all operations of the BS 300. The processor 304 controls the general operation of the BS 300 and can include one or more processing circuits or modules such as a central processing unit (CPU) and/or any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable circuits, devices and/or structures that can perform calculations or other manipulations of data.

The memory 306, which can include both read-only memory (ROM) and random access memory (RAM), can provide instructions and data to the processor 304. A portion of the memory 306 can also include non-volatile random access memory (NVRAM). The processor 304 typically performs logical and arithmetic operations based on program instructions stored within the memory 306. The instructions (a.k.a., software) stored in the memory 306 can be executed by the processor 304 to perform the methods described herein. The processor 304 and memory 306 together form a processing system that stores and executes software. As used herein, “software” means any type of instructions, whether referred to as software, firmware, middleware, microcode, etc. which can configure a machine or device to perform one or more desired functions or processes. Instructions can include code (e.g., in source code format, binary code format, executable code format, or any other suitable format of code). The instructions, when executed by the one or more processors, cause the processing system to perform the various functions described herein.

The transceiver 310, which includes the transmitter 312 and receiver 314, allows the BS 300 to transmit and receive data to and from a remote device (e.g., another BS or a UE). An antenna 350 is typically attached to the housing 340 and electrically coupled to the transceiver 310. In various embodiments, the BS 300 includes (not shown) multiple transmitters, multiple receivers, and multiple transceivers. In one embodiment, the antenna 350 is replaced with a multi-antenna array 350 that can form a plurality of beams each of which points in a distinct direction. The transmitter 312 can be configured to wirelessly transmit packets having different packet types or functions, such packets being generated by the processor 304. Similarly, the receiver 314 is configured to receive packets having different packet types or functions, and the processor 304 is configured to process packets of a plurality of different packet types. For example, the processor 304 can be configured to determine the type of packet and to process the packet and/or fields of the packet accordingly.

In a communication system including the BS 300 that can serve one or more UEs, the BS 300 may receive a random access request from a UE for access to the BS 300. In one embodiment, the random access message analyzer 320 receives, via the receiver 314 and from the UE, a first message comprising a number of copies of a preamble for an access to the BS 300. The number may be an integer larger than one. The copies of the preamble may be carried by different uplink random access channel (RACH) occasions respectively.

In one embodiment, the random access message generator 322 generates and transmits, via the transmitter 312 and to the UE, a second message comprising a response to the first message. A response time window is to be utilized by the UE to monitor the second message within the response time window. All of the copies of the preamble are transmitted by the UE before the response time window expires.

The RO/SSB relationship configurator 324 in this example may configure a mapping relationship between downlink synchronized signal block (SSB) and uplink RACH occasion (RO). In various embodiments, the uplink ROs carrying the copies of the preamble are mapped to a same downlink SSB or different SSBs, based on the mapping relationship. The copies of the preamble may have a same preamble index.

In one embodiment, each of the copies of the preamble is received using a different uplink transmitting beam; and the uplink ROs carrying the copies of the preamble are mapped to a same downlink SSB. The second message may be transmitted with an implicit indication to the UE. The second message comprises a response to at least one of the copies of the preamble. The implicit indication can indicate a best beam among the uplink transmitting beams used for transmitting the copies of the preamble. The best beam can be used for performing subsequent uplink transmissions by the UE.

In another embodiment, the uplink ROs carrying the copies of the preamble have a first quantity equal to the number of the copies. The copies of the preamble are received using uplink transmitting beams having a second quantity that is smaller than the first quantity. An association between the uplink ROs and the uplink transmitting beams is in accordance with a pattern determined by either the BS 300 or the UE.

The preamble aggregation configurator 326 in this example may generate and transmit, via the transmitter 312 and to the UE, an indication indicating a preamble aggregation level configured for the UE, such that the UE can determine the number of copies based on the preamble aggregation level. The preamble aggregation configurator 326 may configure different parameters related to the preamble aggregation. In one example, the preamble aggregation configurator 326 may configure a maximum value of preamble aggregation level directly. In another example, the preamble aggregation configurator 326 may configure the maximum value of uplink ROs mapped to a same downlink SSB based on a parameter about SSB per RO. In yet another example, the preamble aggregation configurator 326 may configure the actual preamble aggregation level which indicates the number of copies of preambles to be used by the UE for aggregation. In one embodiment, the UE determines the preamble aggregation level, i.e. the number of copies of preambles, to be not larger than the maximum value, if applicable. In various embodiments, the maximum value can be configured to be any integer larger than 1. In various embodiments, the maximum value can be implicitly determined to be one of 2, 4 or 8, based on a reciprocal of the parameter about SSB per RO.

In one embodiment, the uplink ROs carrying the copies of the preamble are determined based on subsets of a whole set of ROs configured in accordance with the maximum value. The subsets are determined by the UE or configured by the BS 300 with a configuration of a subset size or a quantity of subsets.

In one embodiment, RO indices of the uplink ROs carrying the copies of the preamble are continuous; the uplink ROs are allocated continuously in one of: a time domain, a frequency domain, or a hybrid time-frequency domain. In this embodiment, the uplink ROs are selected from a RO resource set shared by UEs with and without preamble aggregation.

In another embodiment, RO indices of the uplink ROs carrying the copies of the preamble are continuous; the uplink ROs are allocated continuously in one of: a time domain, a frequency domain, or a hybrid time-frequency domain. But in this embodiment, the uplink ROs are selected from one of a plurality of aggregation RO resource sets that are different from and not shared with a legacy RO resource set used by UEs without preamble aggregation. The aggregation RO resource sets are associated with different preamble aggregation levels respectively.

In yet another embodiment, RO indices of the uplink ROs carrying the copies of the preamble are discontinuous; the uplink ROs are distributed discontinuously in one of: a time domain, a frequency domain, or a hybrid time-frequency domain. In this embodiment, the uplink ROs are selected from a RO resource set shared by UEs with and without preamble aggregation.

In still another embodiment, RO indices of the uplink ROs carrying the copies of the preamble are discontinuous; the uplink ROs are distributed discontinuously in one of: a time domain, a frequency domain, or a hybrid time-frequency domain. But in this embodiment, the uplink ROs are selected from a legacy RO resource set and at least one aggregation set of a plurality of aggregation RO resource sets. A quantity of the at least one aggregation set is determined based on a preamble aggregation level. The legacy RO resource set is shared by UEs with and without preamble aggregation. But the aggregation RO resource sets are only used by UEs with preamble aggregation.

In a different embodiment, RO indices of the uplink ROs carrying the copies of the preamble are discontinuous; the uplink ROs are distributed discontinuously in one of: a time domain, a frequency domain, or a hybrid time-frequency domain. But in this embodiment, the uplink ROs are selected from a legacy RO resource set and a single one of a plurality of aggregation RO resource sets; the legacy RO resource set is shared by UEs with and without preamble aggregation. The aggregation RO resource sets are associated with different preamble aggregation levels respectively and are only used by UEs with preamble aggregation.

The preamble aggregation configurator 326 in this example may also generate and transmit, via the transmitter 312 and to the UE, an indication indicating that the BS 300 supports a combination of multiple preamble receptions. Upon receiving this indication, the UE can determine whether to perform a preamble aggregation based on a transmit power. For example, the first message is transmitted with preamble aggregation by the UE based on a determination that a transmit power of the UE reaches or exceeds a maximum power based on power ramping for random access, and the UE does not get an access to the BS 300. In one embodiment, the random access message generator 322 may further receive, from the UE, an additional first message with an increased preamble aggregation level, when a counter of power ramping increases after transmitting the first message by the UE.

The random access message generator 322 may generate the second message based on a combination of all successfully received copies of the preamble. In one embodiment, the second message comprises an indication indicating a preamble aggregation level associated with the first message, such that any device receiving the second message can determine whether the second message is for the device based on the indication.

The power module 308 can include a power source such as one or more batteries, and a power regulator, to provide regulated power to each of the above-described modules in FIG. 3. In some embodiments, if the BS 300 is coupled to a dedicated external power source (e.g., a wall electrical outlet), the power module 308 can include a transformer and a power regulator.

The various modules discussed above are coupled together by a bus system 330. The bus system 330 can include a data bus and, for example, a power bus, a control signal bus, and/or a status signal bus in addition to the data bus. It is understood that the modules of the BS 300 can be operatively coupled to one another using any suitable techniques and mediums.

As used herein, the term “layer” refers to an abstraction layer of a layered model, e.g. the open systems interconnection (OSI) model, which partitions a communication system into abstraction layers. A layer serves the next higher layer above it, and is served by the next lower layer below it.

Although a number of separate modules or components are illustrated in FIG. 3, persons of ordinary skill in the art will understand that one or more of the modules can be combined or commonly implemented. For example, the processor 304 can implement not only the functionality described above with respect to the processor 304, but also implement the functionality described above with respect to the random access message analyzer 320. Conversely, each of the modules illustrated in FIG. 3 can be implemented using a plurality of separate components or elements.

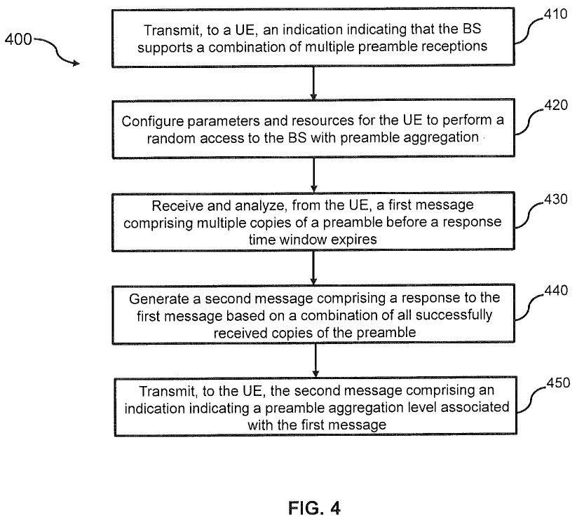

FIG. 4 illustrates a flow chart for a method 400 performed by a BS, e.g. the BS 300 in FIG. 3, for performing preamble aggregation in a random access procedure, in accordance with some embodiments of the present disclosure. At operation 410, the BS transmits, to a UE, an indication indicating that the BS supports a combination of multiple preamble receptions. At operation 420, the BS can optionally configure parameters and resources for the UE to perform a random access to the BS with preamble aggregation. At operation 430, the BS receives and analyzes, from the UE, a first message comprising multiple copies of a preamble before a response time window expires. At operation 440, the BS generates a second message comprising a response to the first message based on a combination of all successfully received copies of the preamble. At operation 450, the BS transmits, to the UE, the second message comprising an indication indicating a preamble aggregation level associated with the first message. According to various embodiments, the order of the above operations may be changed.

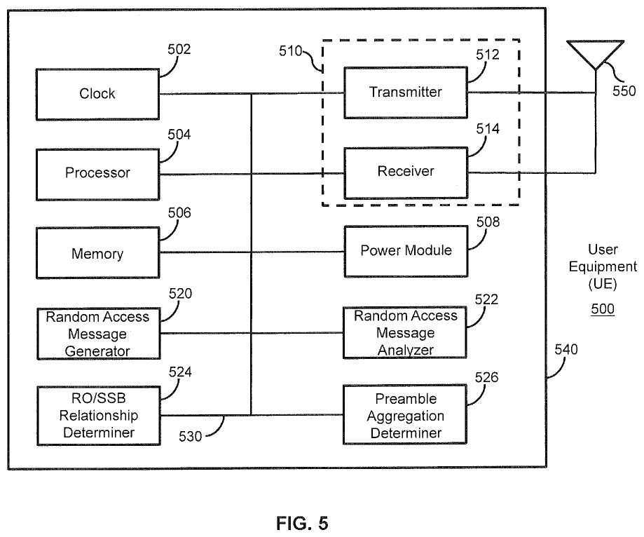

FIG. 5 illustrates a block diagram of a user equipment (UE) 500, in accordance with some embodiments of the present disclosure. The UE 500 is an example of a device that can be configured to implement the various methods described herein. As shown in FIG. 5, the UE 500 includes a housing 540 containing a system clock 502, a processor 504, a memory 506, a transceiver 510 including a transmitter 512 and a receiver 514, a power module 508, a random access message generator 520, a random access message analyzer 522, a RO/SSB relationship determiner 524, and a preamble aggregation determiner 526.

In this embodiment, the system clock 502, the processor 504, the memory 506, the transceiver 510 and the power module 508 work similarly to the system clock 302, the processor 304, the memory 306, the transceiver 310 and the power module 308 in the BS 300. An antenna 550 or a multi-antenna array 550 is typically attached to the housing 540 and electrically coupled to the transceiver 510.

In a communication system, the UE 500 may want to access a BS for data transfer. In one embodiment, the random access message generator 520 may generate a first message comprising a number of copies of a preamble for an access to the BS. The number may be an integer larger than one. In one embodiment, the random access message generator 520 transmits, via the transmitter 512 and to the BS, the first message for an access to the BS. The copies of the preamble may be carried by different uplink random access channel (RACH) occasions respectively.

In one embodiment, the random access message analyzer 522 may monitor, within a response time window, for a second message comprising a response to the first message from the BS. All of the copies of the preamble are transmitted before the response time window expires.

The RO/SSB relationship determiner 524 in this example may determine a mapping relationship between downlink synchronized signal block (SSB) and uplink RACH occasion (RO). In various embodiments, the uplink ROs carrying the copies of the preamble are mapped to a same downlink SSB or different downlink SSBs, based on the mapping relationship. The copies of the preamble may have a same preamble index.

In one embodiment, each of the copies of the preamble is transmitted using a different uplink transmitting beam; and the uplink ROs carrying the copies of the preamble are mapped to a same downlink SSB. The random access message analyzer 522 may receive, via the receiver 514 and from the BS, the second message with an implicit indication. The second message comprises a response to at least one successfully received copy of the preamble. The implicit indication can indicate a best beam among the uplink transmitting beams used for transmitting the copies of the preamble. The best beam can be used for performing future uplink transmissions by the UE 500.

In another embodiment, the uplink ROs carrying the copies of the preamble have a first quantity equal to the number of the copies. The copies of the preamble are received using uplink transmitting beams having a second quantity that is smaller than the first quantity. An association between the uplink ROs and the uplink transmitting beams is in accordance with a pattern determined by either the BS or the UE 500.

The preamble aggregation determiner 526 in this example may receive, via the receiver 514 and from the BS, and analyze an indication indicating a preamble aggregation level configured for the UE 500, such that the preamble aggregation determiner 526 can determine the number of copies based on the preamble aggregation level. The preamble aggregation determiner 526 may determine different parameters related to the preamble aggregation. For example, the preamble aggregation determiner 526 may determine the number of copies as a preamble aggregation level being no larger than a maximum value of uplink ROs mapped to a same downlink SSB, wherein the maximum preamble aggregation level may be implicitly or directly indicated from the BS. The maximum value may be determined based on a parameter about SSB per RO or an integer larger 1. In various embodiments, the maximum value can be determined to be one of 2, 4 or 8, based on a reciprocal of the parameter about SSB per RO.

In one embodiment, the preamble aggregation determiner 526 can determine the uplink ROs carrying the copies of the preamble, based on subsets of a whole set of ROs configured in accordance with the maximum value. The subsets are determined by the UE 500 or configured by the BS with a configuration of a subset size or a quantity of subsets.

In one embodiment, RO indices of the uplink ROs carrying the copies of the preamble are continuous; the uplink ROs are allocated continuously in one of: a time domain, a frequency domain, or a hybrid time-frequency domain. In this embodiment, the uplink ROs are selected from a RO resource set shared by UEs with and without preamble aggregation.

In another embodiment, RO indices of the uplink ROs carrying the copies of the preamble are continuous; the uplink ROs are allocated continuously in one of: a time domain, a frequency domain, or a hybrid time-frequency domain. But in this embodiment, the uplink ROs are selected from one of a plurality of aggregation RO resource sets that are different from and not shared with a legacy RO resource set used by UEs without preamble aggregation. The aggregation RO resource sets are associated with different preamble aggregation levels respectively.

In yet another embodiment, RO indices of the uplink ROs carrying the copies of the preamble are discontinuous; the uplink ROs are distributed discontinuously in one of: a time domain, a frequency domain, or a hybrid time-frequency domain. In this embodiment, the uplink ROs are selected from a RO resource set shared by UEs with and without preamble aggregation.

In still another embodiment, RO indices of the uplink ROs carrying the copies of the preamble are discontinuous; the uplink ROs are distributed discontinuously in one of: a time domain, a frequency domain, or a hybrid time-frequency domain. But in this embodiment, the uplink ROs are selected from a legacy RO resource set and at least one aggregation set of a plurality of aggregation RO resource sets. A quantity of the at least one aggregation set is determined based on a preamble aggregation level. The legacy RO resource set is shared by UEs with and without preamble aggregation. But the aggregation RO resource sets are only used by UEs with preamble aggregation.

In a different embodiment, RO indices of the uplink ROs carrying the copies ofthe preamble are discontinuous; the uplink ROs are distributed discontinuously in one of: a time domain, a frequency domain, or a hybrid time-frequency domain. But in this embodiment, the uplink ROs are selected from a legacy RO resource set and a single one of a plurality of aggregation RO resource sets; the legacy RO resource set is shared by UEs with and without preamble aggregation. The aggregation RO resource sets are associated with different preamble aggregation levels respectively and are only used by UEs with preamble aggregation.

The preamble aggregation determiner 526 in this example may also receive, via the receiver 514 and from the BS, an indication indicating that the BS supports a combination of multiple preamble receptions. Upon receiving this indication, the UE 500 can determine whether to perform a preamble aggregation based on a transmit power. For example, the preamble aggregation determiner 526 can determine that a transmit power of the UE 500 reaches a maximum power based on power ramping for access to the BS and the UE 500 does not get an access to the BS. The first message is transmitted with preamble aggregation based on this determination. In one embodiment, when a counter of power ramping increases after transmitting the first message, the random access message analyzer 522 can generate and transmit, via the transmitter 512 and to the BS, an additional first message with an increased preamble aggregation level.

In one embodiment, the second message is generated by the BS based on a combination of all successfully received copies of the preamble. The random access message analyzer 522 may also receive, via the receiver 514 and from the BS, and analyze a response message comprising a response to an access message. The response message comprises an indication indicating a preamble aggregation level associated with the access message. Based on the analysis of the indication, the random access message analyzer 522 can determine whether the response message is for the UE 500.

The various modules discussed above are coupled together by a bus system 530. The bus system 530 can include a data bus and, for example, a power bus, a control signal bus, and/or a status signal bus in addition to the data bus. It is understood that the modules of the UE 500 can be operatively coupled to one another using any suitable techniques and mediums.

Although a number of separate modules or components are illustrated in FIG. 5, persons of ordinary skill in the art will understand that one or more of the modules can be combined or commonly implemented. For example, the processor 504 can implement not only the functionality described above with respect to the processor 504, but also implement the functionality described above with respect to the random access message generator 520. Conversely, each of the modules illustrated in FIG. 5 can be implemented using a plurality of separate components or elements.

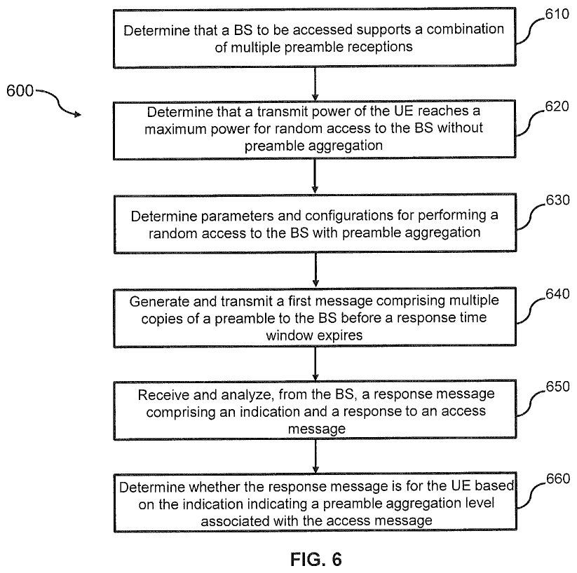

FIG. 6 illustrates a flow chart for a method 600 performed by a UE, e.g. the UE 500 in FIG. 5, for performing preamble aggregation in a random access procedure, in accordance with some embodiments of the present disclosure. At operation 610, the UE determines that a BS to be accessed supports a combination of multiple preamble receptions. At operation 620, the UE determines that a transmit power of the UE reaches a maximum power for random access to the BS without preamble aggregation. At operation 630, the UE determines parameters and configurations for performing a random access to the BS with preamble aggregation. At operation 640, the UE generates and transmits a first message comprising multiple copies of a preamble to the BS before a response time window expires. At operation 650, the UE receives and analyzes, from the BS, a response message comprising an indication and a response to an access message. At operation 660, the UE determines whether the response message is for the UE based on the indication indicating a preamble aggregation level associated with the access message. According to various embodiments, the order of the above operations may be changed.

Different embodiments of the present disclosure will now be described in detail hereinafter. It is noted that the features of the embodiments and examples in the present disclosure may be combined with each other in any manner without conflict.

In a first embodiment, different PRACH aggregation or preamble aggregation schemes are described. While PRACH transmission in a traditional method only occurs once before the response window expires, and retransmission of PRACH may occur only after the response window expires, the present teaching discloses a solution to provide multiple PRACH transmissions before the response window expires.

Schemes of multiple PRACH transmissions could be based on repetition or beam switch. Both of these schemes or a combination of these schemes can be referred to as PRACH aggregation or preamble aggregation. Beam switch can also be regarded as a repetition of preambles with different uplink (UL) transmitting (Tx) beams. The concept of PRACH aggregation may also cover other schemes, without limiting to repetition or beam switch, according to different embodiments of the present teaching.

In one embodiment, a PRACH is a preamble sequence carried by a time-frequency instance called RACH occasion (RO). In most cases, the preamble sequence may have additional cyclic prefix (CP) before the preamble or guard period (GP) after the preamble, where the preamble with cyclic prefix and/or guard period constitutes the PRACH. The multiple PRACH transmissions or PRACH aggregation is mainly related to the multiple PRACH in multiple ROs in this embodiment, but it can also be applied to different preamble sequence aggregation.

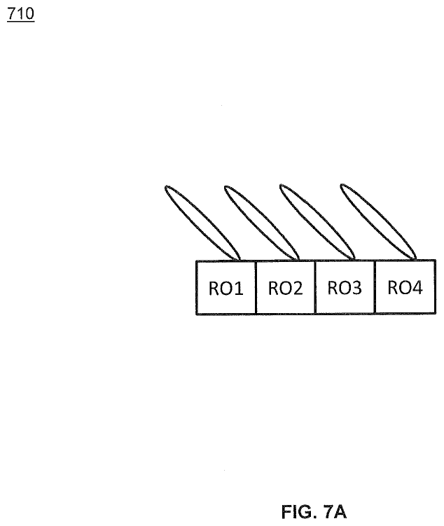

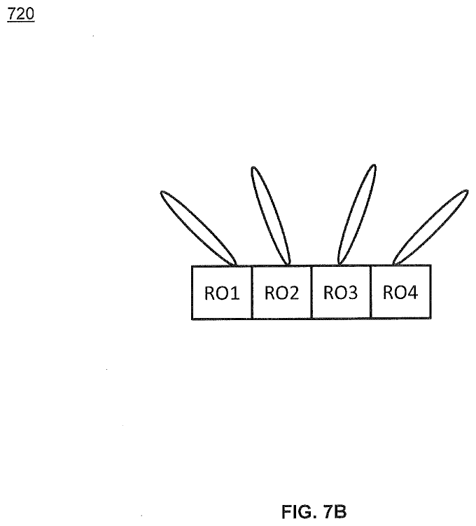

FIG. 7A illustrates an exemplary scheme 710 for preamble aggregation, which is based on a repetition with the same UL Tx beam of the multiple PRACH transmissions (i.e. multiple copies of a preamble) in 4 RACH occasions with the same preamble index, in accordance with some embodiments of the present disclosure. FIG. 7B illustrates another exemplary scheme 720 for preamble aggregation, which is based on a beam switch with different UL Tx beams in 4 RACH occasions for multiple PRACH transmissions with the same preamble index, in accordance with some embodiments of the present disclosure.

The aggregation level or size is four in this example, while it can also be other values, such as any integer larger than 1. The RO index in the aggregation group is continuously increased, from RO1 to RO4. But the RO index is just the logic number of RACH occasion. So the physical ROs in the group may not be continuous in physical time-frequency domain. For example, the physical ROs can cross the slot boundary or have time or frequency gap with other physical ROs.

Regarding the scheme 710 shown in FIG. 7A, the repetitions of PRACH occur in the multiple ROs. The BS or the network could combine the multiple receptions of the multiple PRACH to achieve a combining gain and to improve the uplink coverage performance and/or the successful access probability. In a NR system, the BS or network may broadcast an association between the downlink SSB (synchronized signal block) and the uplink RO, which means there is a mapping relationship between the SSB and RO. For the scheme 710 shown in FIG. 7A, the ROs involved in the repetition of PRACH from one UE are all related to the same SSB.

Regarding the scheme 720 shown in FIG. 7B, there are two different cases regarding whether the ROs in the aggregation group are mapped to the same SSB or different SSBs. If the ROs containing the PRACH are mapped to the same SSB, it is called case (B-1). In this case, the UE attempts to find the best or a fine enough transmitting beam by beam switch in one aggregation group. When the network successfully receives one or multiple PRACH, the network can respond to the one or anyone of the multiple successfully received PRACH, and send a Msg 2 to the UE. The random access radio network temporary identifier (RA-RNTI) scrambled in the Msg 2 on physical downlink control channel (PDCCH) can implicitly indicate UE the best or fine transmitting beam as the RA-RNTI is calculated based on the time-frequency information of the specific RO. The indication of best UL Tx beam could help the next or subsequent uplink transmission, e.g. transmission of Msg 3. From the perspective of the network, the network could combine the receptions of PRACH with different UL Tx beams, where the combination could also improve the coverage, reduce the latency of initial access, and improve the successful access probability.

In one example, when the network successfully receives multiple copies of a preamble transmitted on different UL Tx beams, the network can select a UL Tx beam corresponding to a maximum or suitable receiving power of the preamble copy. The network can implicitly inform the UE about the selected beam based on RA-RNTI scrambled in the Msg 2. The suitable receiving power means the receiving power satisfies a predefined threshold.

If the ROs containing the PRACH are mapped to different SSB, it is called case (B-2). In this case, before the response window expires, the UE could transmit PRACH on different ROs related to different SSBs. This scheme is more suitable for the UE which receives multiple SSBs with almost the same or similar quality. The UE transmits the multiple PRACHs to tell the network a situation of the reception of SSBs, which could reduce the whole latency of initial access procedure.

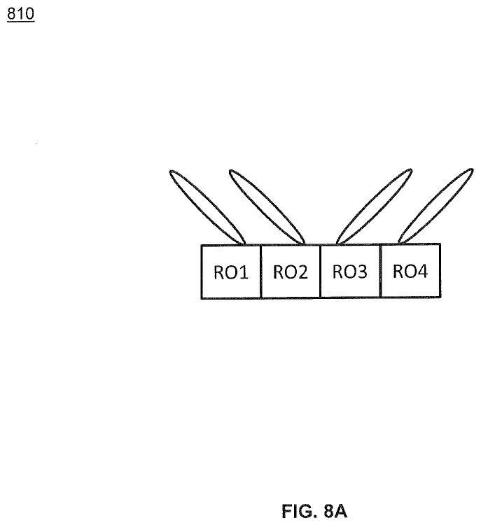

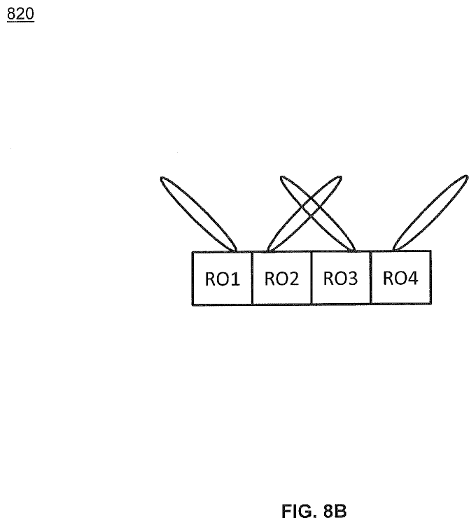

The repetition and beam switch could be combined together in one aggregation group as a hybrid transmission mode, which may be called a hybrid mode or hybrid scheme. Some examples of the hybrid scheme are shown in FIG. 8A and FIG. 8B. These are the typical patterns of hybrid scheme.

FIG. 8A illustrates an exemplary hybrid scheme 810 for preamble aggregation, in accordance with some embodiments of the present disclosure. According to the hybrid scheme 810 shown in FIG. 8A, the PRACH repeats twice at RO1 and RO2, switches the beam at RO3, and repeats the PRACH again at RO4. FIG. 8B illustrates another exemplary hybrid scheme 820 for preamble aggregation, in accordance with some embodiments of the present disclosure. According to the hybrid scheme 820 shown in FIG. 8B, the beam of PRACH switches to a second beam at RO2 compared to a first beam at RO1, and switches back to the first beam at RO3, then switches again to the second beam at RO4. It seems as if the PRACH in RO3 and RO4 are copied from the RO1 and RO2, respectively.

Similar as cases (B-1) and (B-2), the ROs in a group may be mapped to only one SSB or multiple SSBs. For the hybrid scheme, if the ROs in a group are mapped to one same SSB, the UE does not need to have a fixed combination pattern of repetition and beam switch. At any RO, the UE could determine whether the action is to perform repeating or beam switching flexibly and freely. From the network's perspective, there is no difference on the energy accumulation from multiple PRACH receptions, whether the PRACH aggregation is based on repetition or beam switch. If the ROs in a group are mapped to multiple SSBs, the network can configure the pattern of the hybrid scheme.

While the ROs in the examples shown in FIGS. 7A-8B are based on time domain instances, the ROs can also be based on frequency domain instances, or time-frequency hybrid instances. The multiple PRACH transmissions in frequency domain instances may only be applied to UEs with the capability to support multiple PRACH transmissions simultaneously.

For all of the PRACH aggregation schemes described above, the network can determine which scheme could be configured to apply, if the UE's capability satisfies the requirement. In some cases, if the configuration from the network is absent, the UE could take its own decision on the scheme selection. For example, in case that the ROs in a group are mapped to one same SSB, the UE could freely select one of the schemes described above, with a premise that the network indicates to the UE that the network supports a combination of multiple PRACH receptions.

In a second embodiment, the PRACH aggregation size or level is described. In the examples shown in FIGS. 7A-8B, if the ROs in a group are mapped to only one SSB, the PRACH aggregation size or level is 4. This value is the number of multiple PRACH transmissions. The maximum aggregation level or actual aggregation level can be configured by the network for the UE. Alternatively, the aggregation level may be determined by the UE itself.

For a situation when the aggregation level is determined by the UE, the UE measures the downlink signal power level or path loss, to evaluate the receiving signal quality and determine a suitable aggregation level for multiple PRACH transmissions. The value of the aggregation level has no specific upper bound limit, where a maximum value of aggregation level depends on the MCL (maximum couple loss) in the system. For example, the signal-to-interference-plus-noise ratio (SINR) of the accumulation of multiple PRACH receptions should satisfy the minimum sensitivity requirement when the UE reaches the MCL.

In one embodiment, if the multiple PRACH transmissions share the legacy RO resource with UEs without aggregation, the maximum value of aggregation level is limited by the parameter of ssb-perRACH-Occasion. In one embodiment, the value set of ssb-perRACH-Occasion is {⅛, ¼, ½, 1, 2, 4, 8, 16}, which means the number of RO per SSB is a reciprocal of ssb-perRACH-Occasion, which is {8, 4, 2, 1, ½, ¼, ⅛, 1/16}. Only the values {8, 4, 2} of RO per SSB can support the multiple PRACH transmission, assuming the ROs for preamble aggregation in a group are mapped to the same SSB. For example, the maximum value of aggregation level is 8 when ssb-perRACH-Occasion=⅛. The network can configure the maximum value of aggregation level as the reciprocal of ssb-perRACH-Occasion, which may be 2, 4, or 8. For the aggregation level determined by UE, it should not go beyond the reciprocal of ssb-perRACH-Occasion, in this scenario.

Whether the maximum aggregation level is configured by the network or determined by UE itself, the UE has the discretion to decide the actual aggregation level, which is not larger than the maximum aggregation level. For example, if the maximum aggregation level is 4, the UE could repeat 2 times of PRACH.

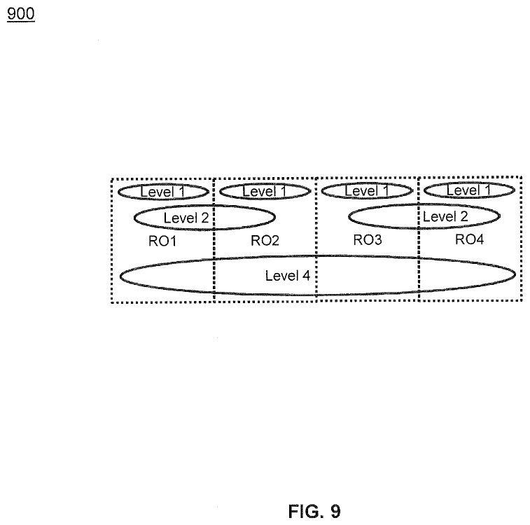

In general, a UE can determine to use a sub-set of the ROs in the whole set of ROs determined by the maximum aggregation level. For example, FIG. 9 illustrates exemplary allocations 900 of random access channel (RACH) occasions for different aggregation levels, in accordance with some embodiments of the present disclosure. As shown in FIG. 9, the whole set of ROs in this case is: {RO1, RO2, RO3, RO4}, while the UE can use different RO combinations or sub-sets for different preamble aggregation levels. For example, the UE can use any of the RO1, RO2, RO3, RO4 as level 1 aggregation, in the set of {RO1, RO2, RO3, RO4}; the UE can also use any of the {RO1, RO2}, {RO3, RO4} as level 2 aggregation in the set of {RO1, RO2, RO3, RO4}; the UE can also use the set of {RO1, RO2, RO3, RO4} as level 4 aggregation. For a same aggregation level, the RO sub-sets do not overlap each other.

In addition to or in alternative to the RO sub-set size determined by UE itself, the RO sub-set size of an aggregation group can also be indicated to UE by the network. In one example, the indication can indicate that the maximum size of the RO group is 4, while the network configures the sub-set size to be 2, which means only the level 2 aggregation with sub-sets of {RO1, RO2}, {RO3, RO4} can be adopted. In one embodiment, the indication of sub-set size can be replaced by the number of sub-sets. In the above example, the network can indicate that the number of sub-sets is 2.

In a third embodiment, distributed and localized PRACH resource allocations for preamble aggregation are described. As discussed above, the RO indices in the aggregation group are logic numbers of RACH occasions and continuously increased in the first embodiment. The ROs in the group with continuous increasing indices are regarded as localized PRACH resources for aggregation. Alternatively, a distributed PRACH resource arrangement for the ROs in the aggregation group can be applied to all the embodiments.

The distributed resource allocation means the indices of the resources are not continuous. Among the following four examples of resource allocations, the first to third examples are shown to illustrate how the resources are distributed and how to use the distributed resources for PRACH aggregation; while the fourth example is to allocate individual RO resource sets for different aggregation sizes or levels.

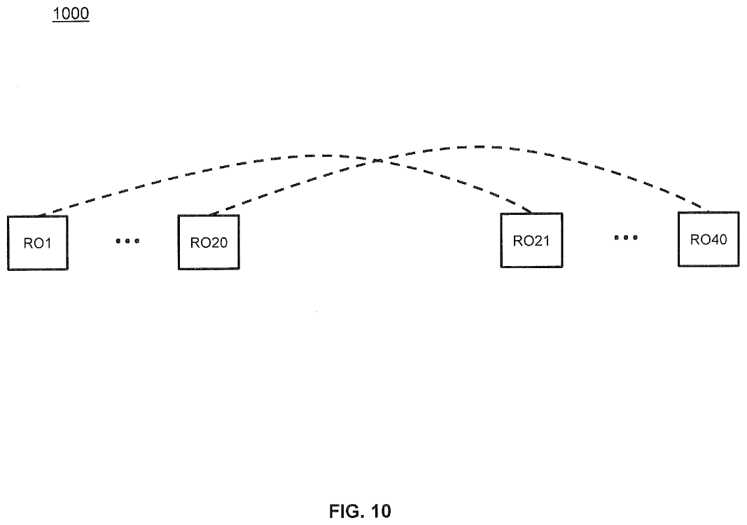

According to a first example, FIG. 10 illustrates a resource allocation 1000 of distributed RACH occasions (ROs) for preamble aggregation. In accordance with FIG. 10, the legacy UEs without PRACH aggregation and the UEs with PRACH aggregation are sharing the same RO resource set from {RO1, RO2, . . . , RO20, RO21, . . . , RO40}. In this example, for the UEs with PRACH aggregation, the aggregation level is 2, and two sub-sets of the RO resources are determined as {RO1, . . . , RO20} and {RO21, . . . , RO40}, assuming there are 20 SSBs in this example. The aggregation groups are {RO1, RO21}, {RO2, RO22}, . . . , {RO20, RO40}. As such, in each group, the indices of RO are not continuous, and the gap between two RO indices in a same group is a constant, which is 20 in this example. The aggregation level can be extended to a larger number, e.g. 4, 8, 16, etc., which means more sub-sets of all the RO resources are segmented and determined as well. This distributed resources scheme is better for backward compatibility if there are more than 2, 4, 8, 16 mapping cycles in the SSB-to-RO association period, as there is no need to restrict the parameter of ssb-perRACH-Occasion to be less than 1. The latency of aggregation may be long due to a larger RO index gap in the group. As the RO resources are shared by the legacy UEs (UEs without PRACH aggregation) and the UEs with PRACH aggregation, it is difficult to blindly distinguish the legacy UEs and the UEs with PRACH aggregation from the network side. In this example, the legacy UEs without PRACH aggregation and the UEs with PRACH aggregation are sharing the same RO resource set, but the PRACH resources for one aggregation group are distributed.

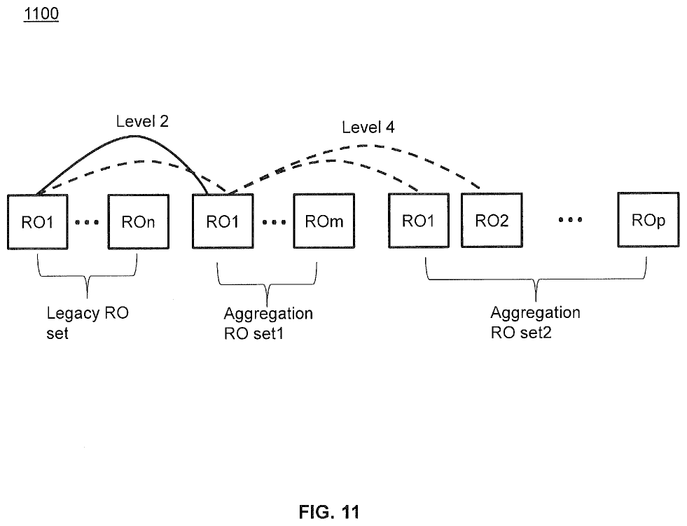

According to a second example, FIG. 11 illustrates another exemplary resource allocation 1100 of distributed ROs for preamble aggregation. In accordance with FIG. 11, the legacy UEs without PRACH aggregation and the UEs with PRACH aggregation are partially sharing the RO resource sets. The legacy RO set is shared between the legacy UEs and the UEs with PRACH aggregation. But the newly added aggregation RO set 1 and set 2 are only for the UEs with PRACH aggregation and not used by the legacy UEs. For an aggregation level of 2, both the legacy RO set and aggregation RO set 1 are involved. For example, RO1 in legacy RO set and RO1 in aggregation RO set 1 are aggregated together. For an aggregation level of 4, the legacy RO set, the aggregation RO set 1, and the aggregation RO set 2 are all involved. For example, RO1 in legacy RO set, RO1 in aggregation RO set 1, and RO1, RO2 in aggregation RO set 2 are aggregated together to build the four times repetition or beam switch. More aggregation sizes or levels are permitted if more aggregation RO sets are provided. In this example of distributed resource arrangement, the RO sets can be cascaded to be used for legacy UEs and UEs with different aggregation levels, as shown in FIG. 11.

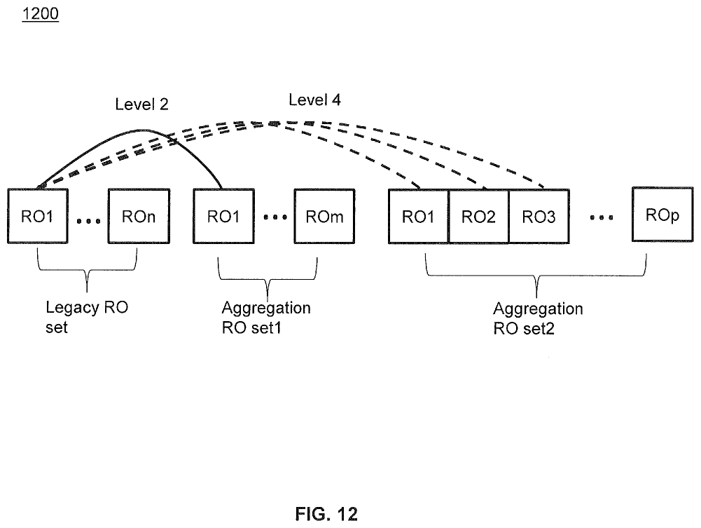

According to a second example, FIG. 12 illustrates yet another exemplary resource allocation 1200 of distributed ROs for preamble aggregation. In accordance with FIG. 12, the legacy UEs without PRACH aggregation and the UEs with PRACH aggregation are partially sharing the RO resource sets. The legacy RO set is shared between the legacy UEs and the UEs with PRACH aggregation. Different from the allocation in FIG. 11, the new added aggregation RO sets are not cascaded for using. Only one aggregation RO set are used with the legacy RO set for the PRACH aggregation for each given aggregation level. For example, for an aggregation level of 2, only aggregation RO set 1 and the legacy RO set are involved in the PRACH aggregation. For an aggregation level of 4, only aggregation RO set 2 and the legacy RO set are involved in the PRACH aggregation, while the aggregation RO set 1 is not related to the case when the aggregation level is 4. In this example of distributed resource arrangement, the aggregation RO sets will be separately and individually used for UEs with different aggregationlevels, together with the legacy RO set.

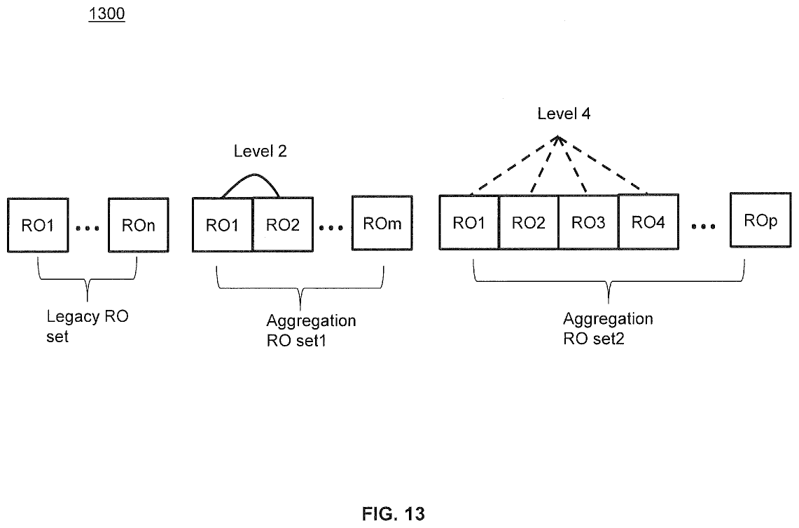

According to a second example, FIG. 13 illustrates an exemplary resource allocation 1300 of localized ROs for preamble aggregation. In accordance with FIG. 13, the legacy UEs without PRACH aggregation and the UEs with PRACH aggregation are not sharing any kU resources. Each aggregation RO set is intended to be used for a respective aggregation level accordingly. For example, the aggregation RO set 1 is only used for PRACH aggregation with an aggregation level of 2; the aggregation RO set 2 is only used for PRACH aggregation with an aggregation level of 4. More aggregation levels can be performed with more individual aggregation RO sets. In this example, the RO resources arrangement for PRACH aggregation in each aggregation set is localized. In other examples, the RO resources arrangement for PRACH aggregation in each aggregation set can also be distributed (not shown).

In a fourth embodiment, PRACH aggregation with power ramping is described. A UE has its discretion to decide when to process the PRACH aggregation. One typical condition for PRACH aggregation is that the UE transmitting power has reached the maximum permitted power level. Then PRACH aggregation can be used to improve the initial access performance. In one example, for each transmission failure, a counter of power ramping is increased by one to instruct the transmitting power level to be increased by one level. When the counter of power ramping k=k0, the transmitting power level of UE reaches or exceeds the maximum power. If the power ramping counter keeps running, and when k=k0+1, the UE will aggregate the PRACH with an aggregation level=2; when k=k0+2, the UE will aggregate the PRACH with an aggregation level=4. More aggregation levels may be added if the power ramping counter keeps running after each attempt.

In a fifth embodiment, an indication in Msg 2 is described for indicating aggregation level. As the PRACH resources for the UEs with PRACH aggregation and the PRACH resources for legacy UEs may overlap, different second messages (Msg 2) for random access response on PDCCH for the legacy UEs and the UEs with PRACH aggregation may be scrambled by the same RA-RNTL. A UE with PRACH aggregation cannot distinguish automatically whether the random access response is especially for the UE itself or a legacy UE. In this embodiment, some additional indication within Msg 2 may be used to for the UE to identify whether the Msg 2 on the PDCCH and PDSCH is for the UE or not. For example, the network can identify an aggregation level by a blind detection of the aggregated PRACH. Then, the network can generate an indication to indicate the detected aggregation level of the PRACH aggregation, and transmit the indication to the UE through the Msg 2. In one case, the indication may indicate the detected aggregation level to be one, to indicate that the Msg 2 is for a legacy UE without aggregation.

According to various embodiments of the present teaching, the network can determine which PRACH aggregation scheme to be configured for a UE. If the configuration of PRACH aggregation scheme from network is absent, the UE can take its own decision on the scheme selection. The network may indicate to the UE that the network has the capability to support the combination of multiple PRACH receptions. The PRACH aggregation means multiple PRACH transmission aggregated in multiple ROs with the same preamble index or aggregated within different preamble sequences. The PRACH aggregation schemes may comprise a PRACH repetition with the same UL Tx beam or a beam switch with different UL Tx beams. The hybrid of repetition and beam switch may also be an alternative for PRACH aggregation schemes, where the pattern of hybrid repetition and beam switch can be configured by the network for the UE.

According to various embodiments of the present teaching, the maximum aggregation level or actual aggregation level can be configured by the network for the UE, or based on a determination of the UE itself. If the multiple PRACH transmissions share the legacy RO resource with UEs without preamble aggregation, the maximum value of aggregation level is limited by a reciprocal of the parameter of ssb-perRACH-Occasion. Sub-sets in the whole set of the ROs determined by the maximum aggregation level are used for PRACH aggregation. Each sub-set is determined by the UE itself. Alternatively, the sub-set size or the number of sub-sets can be configured for the UE.

According to various embodiments of the present teaching, the PRACH resources for aggregation can be distributed and/or localized. There are at least five possible resources arrangement schemes to be considered: (1) PRACH resources for aggregation are localized, while the legacy UEs without PRACH aggregation and the UEs with PRACH aggregation share the same RO resource set; (2) PRACH resources for aggregation are localized in each RO resource set, with different individual RO resource sets configured for different aggregation sizes or levels, where the legacy PRACH resource set is not allowed to be used for the UEs with PRACH aggregation; (3) PRACH resources for aggregation are distributed, where the legacy UEs without PRACH aggregation and the UEs with PRACH aggregation share the same RO resource set; (4) PRACH resources for aggregation are distributed, where the legacy RO set and the aggregation RO sets will be cascaded to be used for UEs with different aggregation levels; (5) PRACH resources for aggregation are distributed, where the aggregation RO sets will be separated and individually used for UEs with different aggregation levels, together with the legacy RO set.

According to various embodiments of the present teaching, a UE will aggregate the PRACH transmission on a condition that its transmitting power reaches or exceeds the maximum transmitting power for random access. The level of PRACH aggregation will increase as the power ramping counter keeps running. In one embodiment, the level of PRACH aggregation can be indicated to the UE through the Msg 2 by the network.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques.

To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, module, etc. can be configured to perform one or more of the functions described herein. The term “configured to” or “configured for” as used herein with respect to a specified operation or function refers to a processor, device, component, circuit, structure, machine, module, etc. that is physically constructed, programmed and/or arranged to perform the specified operation or function.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed is:

1. A method performed by a wireless communication device for preamble aggregation, the method comprising:
transmitting, to a wireless communication node, a first message comprising a number of copies of a preamble for an access to the wireless communication node, wherein the number is an integer larger than one, and wherein the copies of the preamble are carried by different uplink random access channel (RACH) occasions respectively; and
monitoring, within a response time window, for a second message comprising a response to the first message from the wireless communication node, wherein all of the copies of the preamble are transmitted before the response time window expires.

2. The method of claim 1, further comprising:
determining a mapping relationship between downlink synchronized signal block (SSB) and uplink RACH occasion (RO), wherein
the uplink ROs carrying the copies of the preamble are mapped to a same downlink SSB, based on the mapping relationship, and
the copies of the preamble have a same preamble index.

3. The method of claim 2, further comprising:
receiving the second message with an implicit indication from the wireless communication node, wherein
the second message comprises a response to at least one successfully received copy of the preamble, and
the implicit indication indicates at least one of the copies of the preamble.

4. The method of claim 1, further comprising:
receiving, from the wireless communication node, an indication indicating a preamble aggregation level configured for the wireless communication device; and
determining the number of copies based on the preamble aggregation level.

5. The method of claim 4, further comprising:
determining the number of copies as a preamble aggregation level being no larger than a maximum value of uplink ROs mapped to a same downlink SSB, wherein the maximum value is determined based on a parameter about SSB per RO.

6. The method of claim 5, further comprising:
determining the uplink ROs carrying the copies of the preamble, based on subsets of a whole set of ROs configured in accordance with the maximum value, wherein the subsets are determined by the wireless communication device or configured by the wireless communication node with a configuration of a subset size or a quantity of subsets.

7. The method of claim 2, wherein:
RO indices of the uplink ROs carrying the copies of the preamble are continuous;
the uplink ROs are allocated continuously in one of: a time domain, a frequency domain, or a hybrid time-frequency domain;
the uplink ROs are selected from one of a plurality of aggregation RO resource sets that are different from and not shared with a legacy RO resource set used by wireless communication devices without preamble aggregation; and
the aggregation RO resource sets are associated with different preamble aggregation levels respectively.

8. The method of claim 1, further comprising determining that a transmit power of the wireless communication device reaches a maximum power based on power ramping, wherein the first message is transmitted with preamble aggregation based on the determining

9. The method of claim 8, wherein when a counter of power ramping increases after transmitting the first message, transmitting an additional first message with an increased preamble aggregation level to the wireless communication node.

10. A wireless communication device configured to perform preamble aggregation, the wireless communication device comprising:
a transceiver configured to transmit, to a wireless communication node, a first message comprising a number of copies of a preamble for an access to the wireless communication node, wherein the number is an integer larger than one, and wherein the copies of the preamble are carried by different uplink random access channel (RACH) occasions respectively; and
at least one processor configured to monitor, within a response time window, for a second message comprising a response to the first message from the wireless communication node, wherein all of the copies of the preamble are transmitted before the response time window expires.

11. The wireless communication device of claim 10, wherein the at least one processor is further configured to determine a mapping relationship between downlink synchronized signal block (SSB) and uplink RACH occasion (RO), wherein
the uplink ROs carrying the copies of the preamble are mapped to a same downlink SSB, based on the mapping relationship, and
the copies of the preamble have a same preamble index.

12. The wireless communication device of claim 11, wherein the transceiver is further configured to receive the second message with an implicit indication from the wireless communication node, wherein the second message comprises a response to at least one successfully received copy of the preamble, and the implicit indication indicates at least one of the copies of the preamble.

13. The wireless communication device of claim 10, wherein:
the transceiver is further configured to receive, from the wireless communication node, an indication indicating a preamble aggregation level configured for the wireless communication device; and
the at least one processor is further configured to determine the number of copies based on the preamble aggregation level.

14. The wireless communication device of claim 13, wherein the at least one processor is further configured to determine the number of copies as a preamble aggregation level being no larger than a maximum value of uplink ROs mapped to a same downlink SSB, wherein the maximum value is determined based on a parameter about SSB per RO.

15. The wireless communication device of claim 14, wherein the at least one processor is further configured to determine the uplink ROs carrying the copies of the preamble, based on subsets of a whole set of ROs configured in accordance with the maximum value, wherein the subsets are determined by the wireless communication device or configured by the wireless communication node with a configuration of a subset size or a quantity of subsets.

16. The wireless communication device of claim 11, wherein:
RO indices of the uplink ROs carrying the copies of the preamble are continuous;
the uplink ROs are allocated continuously in one of: a time domain, a frequency domain, or a hybrid time-frequency domain;
the uplink ROs are selected from one of a plurality of aggregation RO resource sets that are different from and not shared with a legacy RO resource set used by wireless communication devices without preamble aggregation; and
the aggregation RO resource sets are associated with different preamble aggregation levels respectively.

17. The wireless communication device of claim 10, wherein the at least one processor is further configured to determine that a transmit power of the wireless communication device reaches a maximum power based on power ramping, wherein the first message is transmitted with preamble aggregation based on the determining.

18. The wireless communication device of claim 17, wherein when a counter of power ramping increases after transmitting the first message, transmitting an additional first message with an increased preamble aggregation level to the wireless communication node.

19. The wireless communication device of claim 10, wherein the maximum value is determined to be one of 2, 4 or 8, based on a reciprocal of the parameter about SSB per RO.

20. The wireless communication device of claim 11, wherein:
RO indices of the uplink ROs carrying the copies of the preamble are discontinuous;
the uplink ROs are distributed discontinuously in one of: a time domain, a frequency domain, or a hybrid time-frequency domain; and
the uplink ROs are selected from a RO resource set shared by wireless communication devices with and without preamble aggregation.
